(19) United States
(12) Patent Application Publication
(10) Pub. No.: US 2011/0161515 A1
(43) Pub. Date: Jun. 30, 2011

(54) MULTIMEDIA STREAM RECORDING METHOD AND PROGRAM PRODUCT AND DEVICE FOR IMPLEMENTING THE SAME

(75) Inventors: Sheng Yuan CHEN, Taipei County (TW); Shu Fen LIU, Taipei County (TW); Yung Shen CHANG, Taipei County (TW)

(73) Assignee: VIVOTEK INC., Taipei County (TW)

(21) Appl. No.: 12/722,105

(22) Filed: Mar. 11, 2010

(30) Foreign Application Priority Data
Dec. 31, 2009 (TW) 098146428

(51) Int. Cl. G06F 15/16

(52) U.S. Cl. 709/231

(57) ABSTRACT

A multimedia stream recording method, and a program product and a device for implementing the same are presented. The method includes encoding multimedia data into multimedia streams and storing the multimedia streams in a queue; detecting an event; recording the multimedia streams in a storage device at a low frame rate in a normal recording mode; when the event occurs, converting the multimedia streams stored in the queue before a time point when the event occurs into the specific file format and storing the multimedia streams in the storage device according to a preset condition; and converting the multimedia streams in a preset time range after the time point when the event occurs into the specific file format and then storing the multimedia streams in the storage device, and subsequently recovering a normal storage mode.

### CROSS-REFERENCE TO RELATED APPLICATIONS

This non-provisional application claims priority under 35 U.S.C. §119(a) on Patent Application No(s). 098146428 filed in Taiwan, R.O.C. on Dec. 31, 2009, the entire contents of which are hereby incorporated by reference.

### BACKGROUND OF THE INVENTION

1. Field of Invention

The present invention relates to a video processing technology, and more particularly to a multimedia stream recording method and a program product and a device for implementing the same.

2. Related Art

Due to the bulkiness of a multimedia video/audio file, formerly, for viewing through the network, the file first needs to be downloaded completely to a local machine, and then viewed using multimedia playback software, so it is rather inconvenient to view the file in a mobile device having a limited storage capacity, for example, a personal digital assistant (PDA), a PDA cell phone, or the like product. In order to solve this problem, the multimedia streaming technology is developed. With the development of multimedia technology and popularization of broadband networks, the multimedia streaming technology is more and more widely applied, for example, entertainment, news, and business applications on the network. In brief, with the multimedia streaming technology, the client does not need to wait until downloading of bulky files is completed before enjoying a film or music. In addition to this, one important application of the multimedia streaming is security surveillance, and the application field of security surveillance products is, for example, a digital video recorder (DVR), a background storage product (e.g. network video recorder, NVR), and video-surveillance-software of an Internet Protocol camera (IP camera). With an IP camera supporting Internet applications, the multimedia streaming technology, and a portable electronic device supporting network access, remote surveillance, and multimedia streaming technology at the same time, the user can monitor real-time pictures shot by the IP camera with the portable electronic device at any time and any place.

No matter in a conventional monitoring device or a modern remote real-time surveillance system, to ensure no loss of important data, video is recorded in a continuous recording mode. This mode requires a large amount of storage space and is difficult to be implemented in a portable electronic device using a memory or flash memory card; and also occupies a large amount of storage space and influences the recording time of multimedia data or video. On the other hand, for the remote real-time surveillance system such as an NVR or video-surveillance-software of an IP camera, in order to continuously record and store data, a high transmission bandwidth is required for data transmission, which also occupies many network resources.

In order to solve this problem, some known surveillance systems determine whether an event occurs in surveilled video by video analysis, and only start recording and storing data when a certain event occurs. Although the storage space required for recording and storing data can be greatly reduced in this manner, important information may easily get lost, for example, information before the event occurs is not recorded in such a mode of not recording and storing data until an event occurs.

### SUMMARY OF THE INVENTION

Accordingly, the present invention is a multimedia stream recording method, capable of saving required storage space and capacity and extending a recording time by dynamically adjusting a recording mode of multimedia streams before and after a time point when an event occurs, and recording important information before and after the time point when the event occurs.

The present invention provides a method for recording multimedia data streams. An embodiment of the method of the present invention comprises the following steps.

Multimedia data is encoded into multimedia streams and the multimedia streams are stored in a queue.

An event is detected and a trigger signal is generated to change a recording mode when the event occurs.

In a normal state, the multimedia streams in the queue are converted into a specific file format and recorded in a storage device at a low frame rate in a normal recording mode.

When the event occurs, the multimedia streams stored in the queue before a time point when the event occurs are converted into the specific file format and then stored in the storage device according to a preset condition.

The multimedia streams in a preset time range after the time point when the event occurs are converted into the specific file format and then stored in the storage device, and subsequently a normal storage mode is recovered.

The embodiment of the method of the present invention further comprises: directly converting the encoded multimedia streams into the specific file format and storing the multimedia streams in the storage device.

The embodiment of the method of the present invention further comprises: providing a control interface for changing setting values of the normal recording mode, a first recording quality, and a second recording quality.

The present invention is further a device for implementing the above multimedia stream recording method, which is applicable to a security surveillance product using the multimedia streaming technology, such as a DVR, a background storage product, video-surveillance-software of an IP camera, and other portable electronic devices supporting network access and remote surveillance.

The present invention provides a device for implementing the above multimedia stream recording method, which comprises an encoder, a buffer, a recorder, an event detector, and an event manager.

The encoder encodes multimedia data into multimedia streams according to an encoding profile (for example, but not limited to, a video profile).

The buffer may be a first-in, first-out (FIFO) buffer and functions as a queue in the above method for storing the multimedia streams.

The recorder converts the multimedia streams in the buffer into a specific file format and stores the multimedia streams in a storage device (local storage or NAS).

The event detector is used for detecting an event and generating a corresponding trigger signal to change a recording mode when the event occurs.

The event manager controls the recorder to run a normal storage mode in a normal state so as to convert the multimedia streams in the buffer into the specific file format and store the multimedia streams in the storage device at a low frame rate. The event manager controls the recorder to convert the multimedia streams stored in the buffer before a time point when the event occurs into the specific file format and then store the multimedia streams in the storage device according to a preset condition when the event occurs, and controls the recorder to convert the multimedia streams in a preset time range after the time point when the event occurs into the specific file format and then store the multimedia streams in the storage device, and subsequently recover the normal storage mode.

### BRIEF DESCRIPTION OF THE DRAWINGS

The present invention will become more fully understood from the detailed description given herein below for illustration only, and thus are not limitative of the present invention, and wherein:

FIG. 1 is a flow chart illustrating a process of an embodiment of a method according to the present invention;

FIG. 2 is a view of an embodiment of a multimedia stream recording method according to the present invention, which shows a normal mode and a storage mode of multimedia streams before and after a time point when an event occurs;

FIG. 3 is a view of an embodiment of the multimedia stream recording method according to the present invention, which shows a normal mode and another storage mode of multimedia streams before and after the time point when the event occurs;

FIG. 4 is an architectural view of an embodiment of a device according to the present invention; and

FIG. 5 is an architectural view of another embodiment of the device according to the present invention.

### DETAILED DESCRIPTION OF THE INVENTION

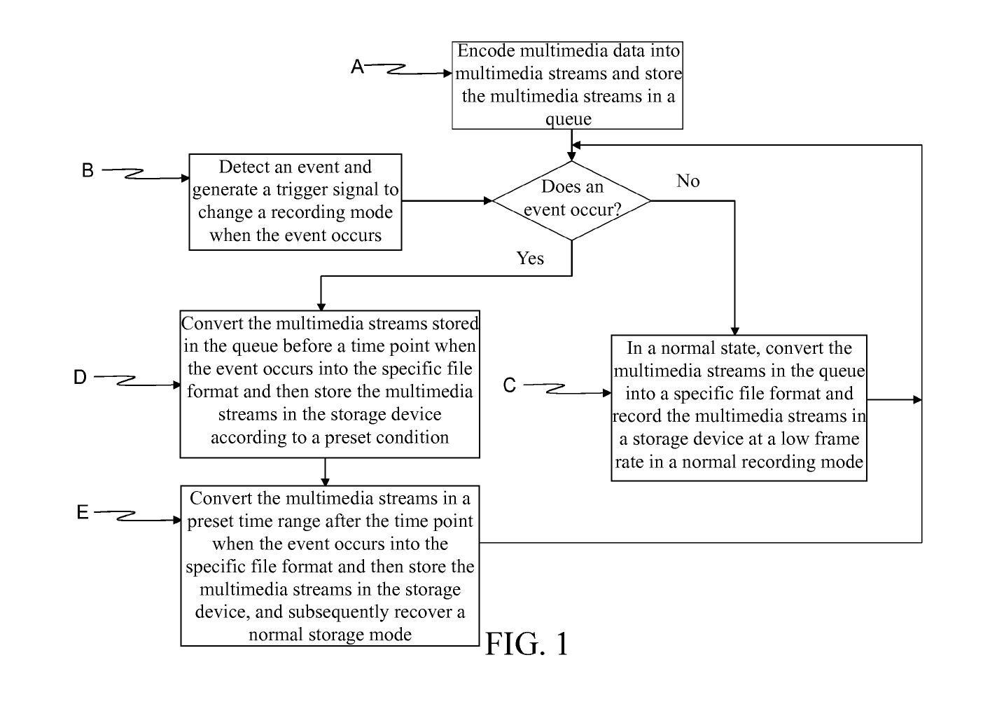

FIG. 1 shows a process of an embodiment of a method according to the present invention, which comprises the following steps.

A. Multimedia data is encoded into multimedia streams and the multimedia streams are stored in a queue.

B. An event is detected and a trigger signal is generated to change a recording mode when the event occurs.

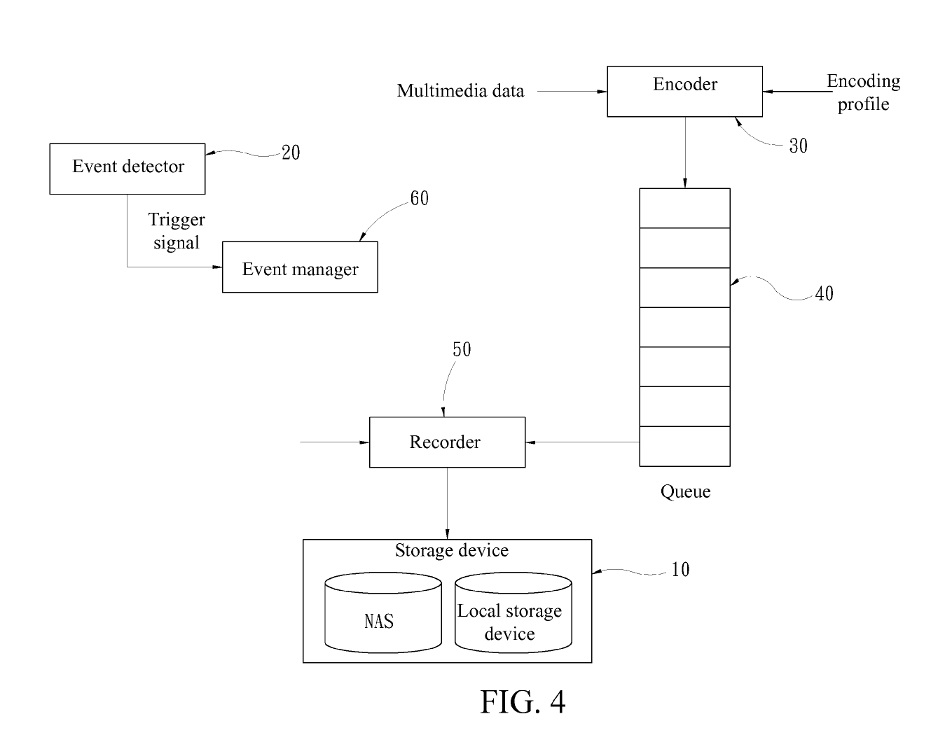

C. In a normal state, the multimedia streams in the queue are converted into a specific file format and recorded in a storage device 10 at a low frame rate in a normal recording mode (referring to FIG. 4).

D. When the event occurs, the multimedia streams stored in the queue before a time point when the event occurs are converted into the specific file format and then stored in the storage device 10 according to a preset condition.

E. The multimedia streams in a preset time range after the time point when the event occurs are converted into the specific file format and then stored in the storage device 10, and subsequently a normal storage mode is recovered.

The above multimedia data comprises video and/or audio. The source of the multimedia data may be digital video and/or audio shot by a photographic device such as a DVR or an IP camera. The event may be detected by, for example, a motion detector, a reed switch for door and window against theft, a face detection module, or other similar event detectors 20 for detecting an event occurring outside and capable of generating a trigger signal. When the detectors detect that a specific event occurs, a trigger signal is generated.

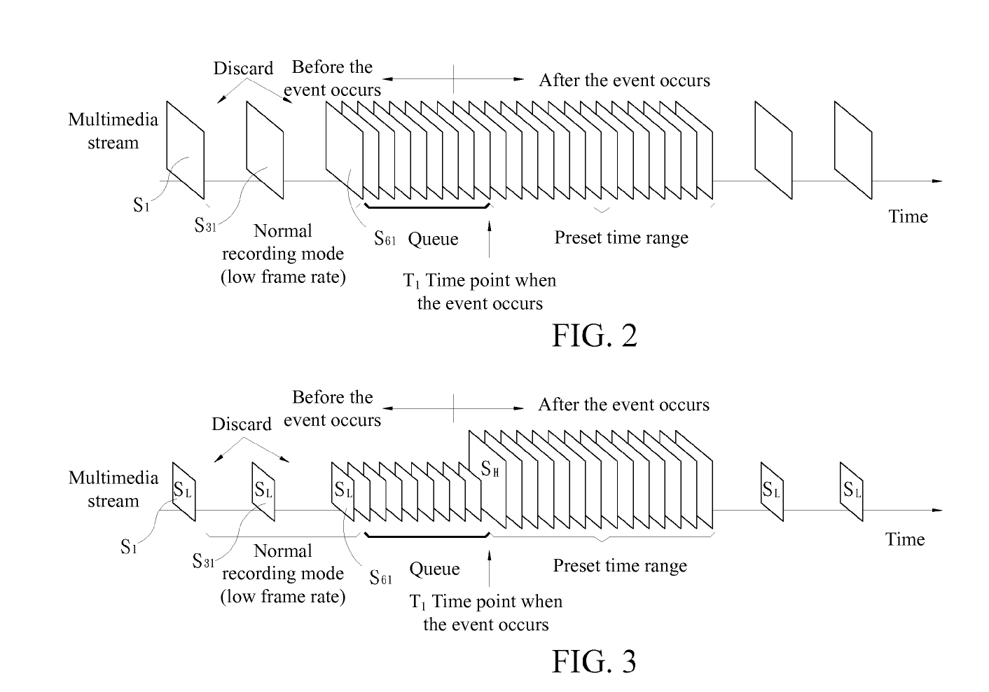

In a normal state when no specific event occurs, the multimedia streams stored in the queue are converted into a specific file format and then recorded in a storage device at a low frame rate in a FIFO order. As shown in the example of FIG. 2, for the multimedia streams stored in the queue before a time point T₁ when an event occurs, first, multimedia streams S₁, S₃₁, and S₆₁ are converted into the specific file format and then recorded in the storage device at a low frame rate, for example, 1 frame per second or a lower frame rate (for example, 1 frame/10 seconds), other multimedia streams between the multimedia streams S₁, S₃₁, and S₆₁ are discarded and eliminated from the queue to prevent the queue space from being filled up, and then, subsequent multimedia streams generated from encoding continue to be stored in the queue based on the queue FIFO principle. In theory, the multimedia data acquired when the event occurs shall be placed in the current queue to become the latest batch of data after being encoded into the multimedia streams, and some multimedia streams still exist in the queue at this time, so that in order to record information before the event occurs, the multimedia streams still stored in the queue before the time point T₁ when the event occurs will be converted into the specific file format and then stored in the storage device 10 according to a preset condition when the event occurs. Here, the preset condition may be that the multimedia streams within a certain time length, for example, a few seconds, or all the multimedia streams currently still existing in the queue are recorded in the storage device 10. Thus, the size of the queue may be adjusted according to requirements to determine the length of time before the event occurs within which the information is recorded. The multimedia streams in a preset time range after the time point when the event occurs are important information, which is completely converted into the specific file format and then stored in the storage device 10. Here, the preset time range may be determined by a time length or the number of frames stored in the storage device 10. For example, if the file format is MPEG-4, the highest frame rate (30 frames/second) of the MPEG-4 format may be used for storage, so as to obtain a better quality.

In an embodiment of the method of the present invention, the specific file format may be any one of *.avi, *.mp4, *.wmv, *.mpg, MPEG-4, and Third Generation Partnership Project (3gpp).

Another embodiment of the method of the present invention (as shown in FIG. 3) further comprises encoding the multimedia data into low-quality multimedia streams S_{L} with a low encoding quality (for example, a low video resolution) in a normal state, thereby reducing the data bulk of the multimedia streams and achieving a better efficacy of saving storage space in combination with the above normal storage mode at the low frame rate. The encoding quality of the multimedia data is raised (for example, a high video resolution) after the time point T₁ when the event occurs, so as to obtain high-quality multimedia streams S_{H}.

The embodiment of the method of the present invention further comprises: directly converting the encoded multimedia streams into the specific file format and storing the multimedia streams in the storage device 10. The storage device may be a local device (for example, a storage device, such as a memory or a memory card, built in a DVR or an IP camera), a hard disk drive, or a network storage device (NAS) supporting the IP camera.

FIG. 4 is an architectural view of an embodiment of a device for implementing the above method according to the present invention. The device comprises an encoder 30, a buffer 40, a recorder 50, an event detector 20, and an event manager 60.

The encoder 30 encodes multimedia data into multimedia streams according to an encoding profile.

The buffer 40 may be a FIFO buffer and functions as a queue in the above method for storing the multimedia streams.

The recorder 50 converts the multimedia streams in the buffer 40 into a specific file format and stores the multimedia streams in a storage device 10.

The event detector 20 is used for detecting an event and generating a corresponding trigger signal to change a recording mode when the event occurs.

The event manager 60 controls the recorder 50 to run a normal storage mode in a normal state so as to convert the multimedia streams in the buffer into the specific file format and store the multimedia streams in the storage device 10 at a low frame rate. The event manager 60 controls the recorder 50 to convert the multimedia streams stored in the buffer 40 before a time point when the event occurs into the specific file format and then store the multimedia streams in the storage device 10 according to a preset condition when the event occurs, and controls the recorder 50 to convert the multimedia streams in a preset time range after the time point when the event occurs into the specific file format and then store the multimedia streams in the storage device 10, and subsequently recover the normal storage mode.

An embodiment of the encoder 30, the recorder 50, and the event manager 60 is implemented by a computer software technology, and then the software comprising the encoder 30, the recorder 50, and the event manager 60 is run at a microprocessor of a DVR, video-surveillance-software of an IP camera, or a streaming server, thereby implementing the above multimedia stream recording method.

Another feasible implementation is to realize the device of the present invention using the technology of system-on-chip (SoC) or embedded system, so as to be applied in a portable electronic device such as a DVR or an IP camera, thereby realizing the function of long-time security surveillance and recording in combination with the photographic function of the DVR and the IP camera per se as well as a memory card built therein or other storage devices.

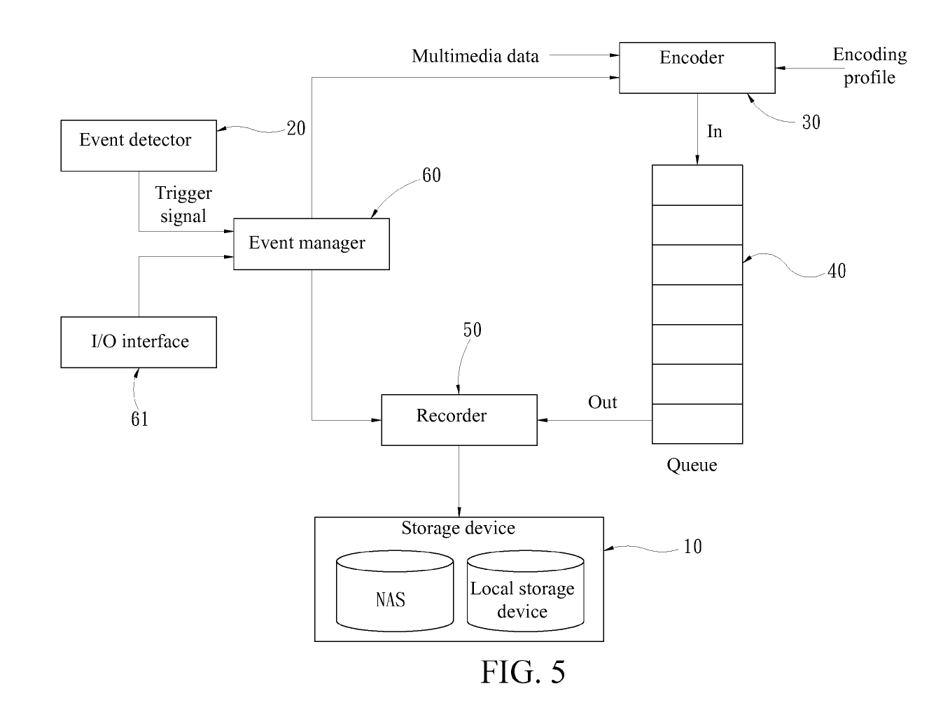

In another embodiment of the device of the present invention (referring to FIG. 5), the event manager 60 further comprises an input/output (I/O) interface 61. The user may control the event manager 60 through the I/O interface 61 to collect or manage events and change the frame-rate setting in the normal recording mode and encoding quality of the encoder 30.

An IP camera applying the device of the present invention may be connected to a personal computer (PC) installed with video-surveillance-software, a network disk drive (NAS) supporting the IP camera, a network video recorder (NVR), or other electronic devices for video recording, so as to achieve the local surveillance function through the electronic devices configured in the same local area network (LAN). In addition, the IP camera may also be connected to the Internet and communicate with a local PC, cell phone, PDA, or receiver box or other remote electronic devices, so that the user may turn on the IP camera through the remote electronic devices to perform remote surveillance and use the remote electronic devices for video recording.

In view of the above, the multimedia stream recording method and the program product and the device for implementing the same in the present invention can achieve the efficacy of saving the storage space and extending the recording time, and can record content before and after an event occurs.

What is claimed is:

1. A multimedia stream recording method, comprising:
encoding multimedia data into multimedia streams and storing the multimedia streams in a queue;
detecting an event and generating a trigger signal to change a recording mode when the event occurs;
in a normal state, converting the multimedia streams in the queue into a specific file format and recording the multimedia streams in a storage device at a low frame rate in a normal recording mode;
when the event occurs, converting the multimedia streams stored in the queue before a time point when the event occurs into the specific file format and then storing the multimedia streams in the storage device according to a preset condition; and
converting the multimedia streams in a preset time range after the time point when the event occurs into the specific file format and then storing the multimedia streams in the storage device, and subsequently recovering a normal storage mode.

2. The multimedia stream recording method according to claim 1, wherein the multimedia data comprises video and/or audio.

3. The multimedia stream recording method according to claim 1, wherein the event occurring outside is detected and the trigger signal is generated by any one of a motion detector, a reed switch for door and window against theft, and a face detection module.

4. The multimedia stream recording method according to claim 1, wherein the specific file format is any one of *.avi, *.mp4, *.wmv, *.mpg, MPEG-4, and Third Generation Partnership Project (3gpp).

5. The multimedia stream recording method according to claim 1, further comprising: encoding the multimedia data into the low-quality multimedia streams with a low encoding quality in the normal state.

6. The multimedia stream recording method according to claim 1, further comprising: directly converting the encoded multimedia streams into the specific file format and storing the multimedia streams in the storage device.

7. The multimedia stream recording method according to claim 1, wherein the preset condition is the multimedia streams within a certain time length.

8. The multimedia stream recording method according to claim 1, wherein the preset condition is all the multimedia streams currently still existing in the queue.

9. A computer program product, for storing therein a program for recording multimedia streams, capable of accomplishing a method according to claim 1 after a computer loads and runs the computer program.

10. A device for implementing a method according to claim 1, comprising:
an encoder, for encoding multimedia data into multimedia streams according to an encoding profile;
a buffer, being a first-in, first-out (FIFO) buffer and functioning as a queue in the method for storing the multimedia streams;
a recorder, for converting the multimedia streams in the buffer into a specific file format and storing the multimedia streams in a storage device;
an event detector, for detecting an event and generating a corresponding trigger signal to change a recording mode when the event occurs; and
an event manager, for controlling the recorder to run a normal storage mode in a normal state so as to convert the multimedia streams in the buffer into the specific file format and store the multimedia streams in the storage device at a low frame rate, controlling the recorder to convert the multimedia streams stored in the buffer before a time point when the event occurs into the specific file format and then store the multimedia streams in the storage device according to a preset condition when the event occurs, and controlling the recorder to convert the multimedia streams in a preset time range after the time point when the event occurs into the specific file format and then store the multimedia streams in the storage device, and subsequently recover the normal storage mode.

11. The device according to claim 10, wherein the multimedia data comprises video and/or audio.

12. The device according to claim 10, wherein the event detector is any one of a motion detector, a reed switch for door and window against theft, and a face detection module.

13. The device according to claim 10, wherein the specific file format is any one of *.avi, *.mp4, *.wmv, *.mpg, MPEG-4, and Third Generation Partnership Project (3gpp).

14. The device according to claim 10, wherein the encoder encodes the multimedia data into the low-quality multimedia streams with a low encoding quality in the normal state.

15. The device according to claim 10, further comprising: an input/output (I/O) interface, wherein the event manager is controlled through the I/O interface to collect or manage the event and change a frame-rate setting in the normal recording mode and an encoding quality of the encoder.

16. The device according to claim 10, wherein the preset condition is the multimedia streams within a certain time length.

17. The device according to claim 10, wherein the preset condition is all the multimedia streams currently still existing in the queue.
